(19) United States
(12) Patent Application Publication
(10) Pub. No.: US 2012/0229389 A1
(43) Pub. Date: Sep. 13, 2012

(54) ILLUMINATED KEYBOARD DEVICE

(75) Inventor: Takeshi NISHINO, Shinagawa (JP)

(73) Assignee: FUJITSU COMPONENT LIMITED, Tokyo (JP)

(21) Appl. No.: 13/414,153

(22) Filed: Mar. 7, 2012

(30) Foreign Application Priority Data
Mar. 7, 2011 (JP) 2011-049010

(51) Int. Cl. G06F 3/02

(52) U.S. Cl. 345/170

(57) ABSTRACT

An illuminated keyboard device includes a keyboard unit having a plurality of pushbuttons with a light passing property and switches operating by pushing operation of the plurality of pushbuttons, a backlight unit emitting light toward the keyboard unit, and a sheet-shaped color changing part with a light passing property interposed between the keyboard unit and the backlight unit to change a color of light emitted from the backlight unit.

### BACKGROUND OF THE INVENTION

1. Field of the Invention

The present invention relates to an illuminated keyboard device having an illumination function used for a personal computer, word processor, or other electronic device.

2. Description of the Related Art

In the past, a keyboard device has been known which arranges a light emitting sheet below the key tops so as to illuminate the key tops. For example, in the device described in Japanese Unexamined Patent Publication (kokai) No. 2001-184975 (JP 2001-184975A), a plurality of light emitting sheets (electroluminescence sheets) differing in emitted color are interposed below the key tops to illuminate the key tops by different colors.

However, in the device described in JP 2001-184975A, change of the illuminated color of the key tops requires change of the specifications of the emitted colors of the light emitting sheets themselves. The cost therefore greatly increases.

### SUMMARY OF THE INVENTION

According to an aspect of the present invention, a illuminated keyboard device including a keyboard unit which has a plurality of pushbuttons with a light passing property and switches which are operated by pushing operations of the plurality of pushbuttons, a backlight unit which emits light toward the keyboard unit, and a sheet-shaped color changing part with a light passing property which is interposed between the keyboard unit and the backlight unit to change a color of light emitted from the backlight unit.

### BRIEF DESCRIPTION OF THE DRAWINGS

The object, features and advantages of the present invention will be further understood from a detailed description of typical embodiments of the present invention shown in the attached drawings, wherein

FIG. 1 is a disassembled perspective view showing the overall configuration of an illuminated keyboard device according to a first embodiment of the present invention,

FIG. 2 is a disassembled perspective view showing the illuminated keyboard device of FIG. 1 more specifically,

FIG. 3 is a disassembled perspective view showing the state of the keyboard unit of FIG. 1 in the middle of assembly,

FIG. 4 is a longitudinal cross-sectional view showing the configuration of a membrane switch of FIG. 2,

FIG. 5 is a perspective view showing the configuration of the gear links of FIG. 2,

FIG. 6 is a longitudinal cross-sectional view showing the assembled state of the illuminated keyboard device according to the first embodiment of the present invention,

FIG. 7 is a view showing the path of light in the assembled state of the illuminated keyboard device according to the first embodiment of the present invention,

FIG. 8 is a disassembled perspective view showing the overall configuration of an illuminated keyboard device according to a second embodiment of the present invention,

FIG. 9 is a view of a modification of FIG. 8,

FIG. 10 is a disassembled perspective view showing the overall configuration of an illuminated keyboard device according to a third embodiment of the present invention,

FIG. 11 is a view of a modification of FIG. 10, and

FIG. 12 is a view of another modification of FIG. 10.

### DETAILED DESCRIPTION

### First Embodiment

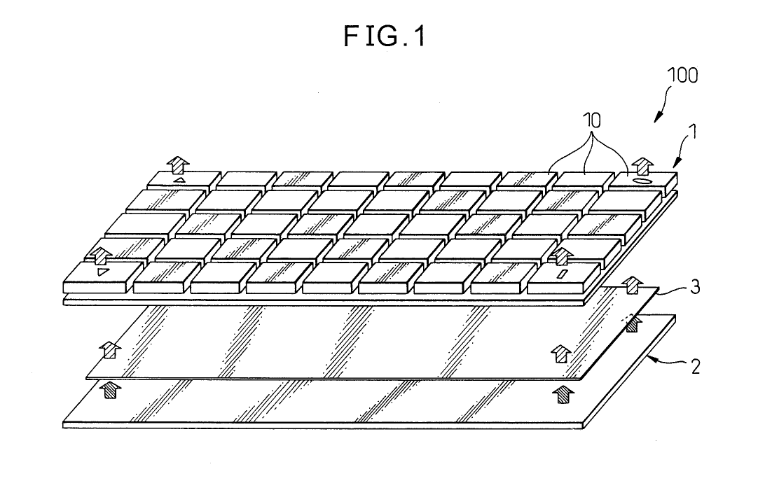

Below, referring to FIG. 1 to FIG. 7, a first embodiment of an illuminated keyboard device according to the present invention will be explained. FIG. 1 is a disassembled perspective view showing the overall configuration of an illuminated keyboard device 100 according to the first embodiment of the present invention. This illuminated keyboard device 100 is used as an input device of a personal computer, word processor, or other electronic device and is provided with a keyboard unit 1, a backlight unit 2 which is arranged below the keyboard unit 1, and a color sheet 3 which is interposed between the keyboard unit 1 and the backlight unit 2. At the top surface of the keyboard unit 1, a plurality of key tops 10 which are operated by being pushed by the user are arranged. Note that, various shapes and arrangements of the key tops 10 may be employed.

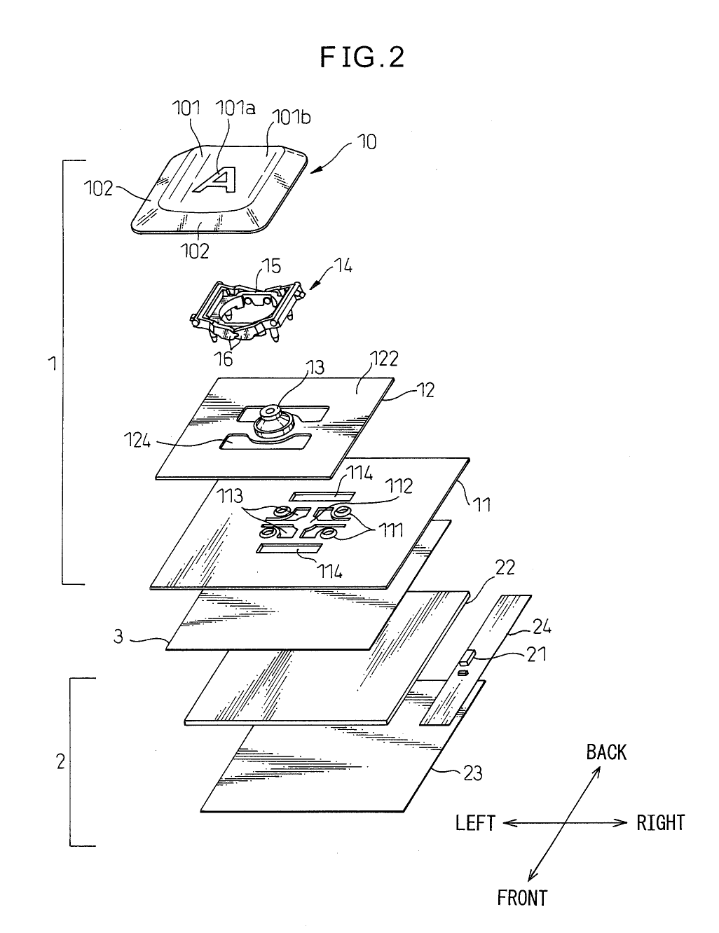

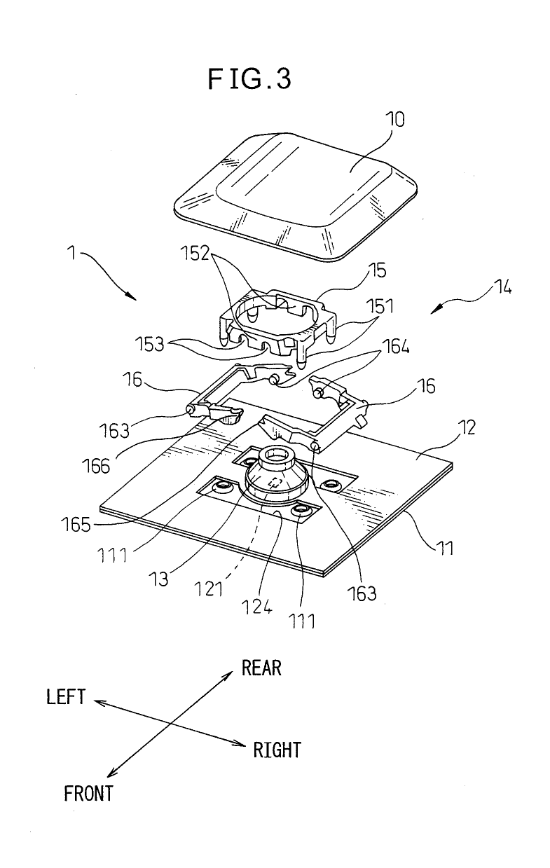

FIG. 2 is a disassembled perspective view showing the illuminated keyboard device 100 of FIG. 1 more specifically, while FIG. 3 is a disassembled perspective view showing the state of the keyboard unit 1 in the middle of assembly. In FIG. 2 and FIG. 3, to facilitate understanding, the configuration corresponding to a single key top 10 is shown. Note that, below, for convenience, the “front”, “back”, “left”, and “right” directions are defined as illustrated. The configurations of the parts will be explained in accordance with these definitions.

As shown in FIG. 2, the keyboard unit 1 has a flat plate-shaped support panel 11, a sheet-shaped membrane switch 12 which is arranged on the top surface of the support panel 11, an operating member 13 which is set on the top surface of the membrane switch 12, a support member 14 which is attached to the support panel 11 through the membrane switch 12, and a key top 10 which is supported in an elevatable manner through the support member 14.

The support panel 11 is configured by aluminum, iron, or another metal or a resin. The support panel 11 has a plurality of (in the figure, four) circular through holes 111, to which the support member 14 is attached. Furthermore, at the inside of the circular through holes 111 and around the center part 112 of the support panel 11, a plurality of (in the figure, four) light-passing through holes 113 for passing light emitted from the backlight unit 2 are formed symmetrically about the center part 112. At the front and rear of the light-passing through holes 113, a pair of long holes 114 are formed in the left-right direction symmetrically about the center part 112. Note that, in the figure, the light-passing through holes 113 are formed along the circular through holes 111, but the light-passing through holes 113 may be any shapes so long as being formed at the inside of the circular through holes 111 while leaving the center part 112 intact.

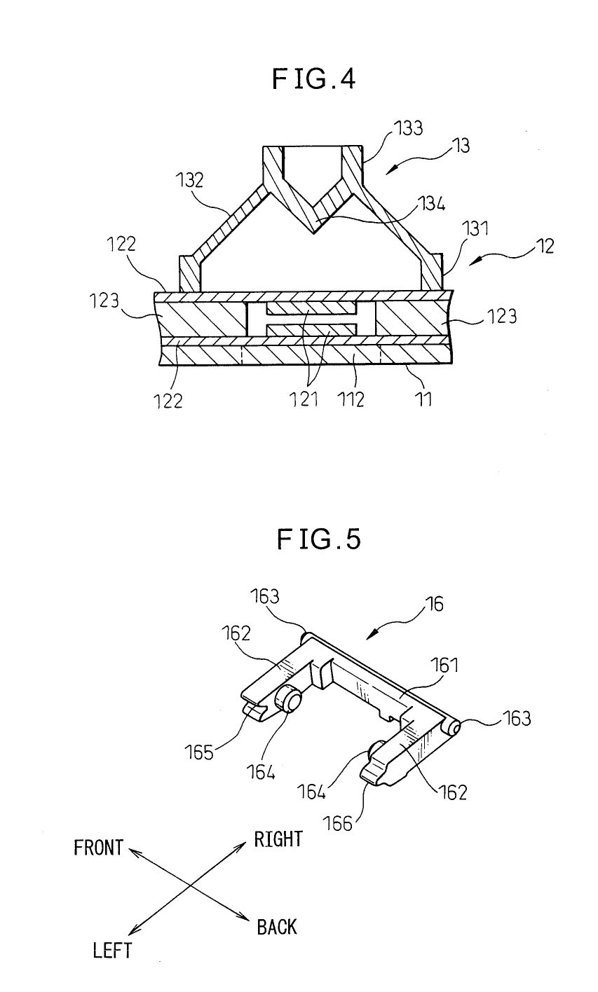

FIG. 4 is a cross-sectional view showing the configuration of a membrane switch 12. The membrane switch 12 has a pair of contacts 121 which are arranged facing each other in the up-down direction, a pair of top and bottom sheet substrates 122 which carry the pair of contacts 121, and a spacer 123 which is arranged between the pair of sheet substrates 122 and separates the sheet substrates from each other by a predetermined distance to hold the two contacts 121 in the open state. The sheet substrates 122 are configured by known flexible printed circuit boards. The surfaces of the film base members are provided with short-circuitable contacts 121.

The pair of sheet substrates 122 are fastened to the support panel 11 by not shown screws etc. In the fastened state, the contacts 121 are arranged above the center part 112 of the support panel 11. The membrane switch 12 is configured by a transparent or semitransparent polyester film etc. and overall has a light passing property. As shown in FIG. 3, the sheet substrates 122 are formed with a pair of elongated front and back long holes 124 so as to surround the left and right circular through holes 111 of the support panel 11.

As shown in FIG. 4, the operating member 13 has a ring-shaped base 131, a circular truncated cone shaped taper 132 rising at an upward slant from the top end of the base 131, and a columnar part 133 positioned at the center of the taper 132 and overall forms a generally dome shape. Below the columnar part 133, a projection 134 is formed projecting out downward inside of the taper 132. The projection 134 is separated from the membrane switch 12 and positioned above the contacts 121. The operating member 13 is a transparent or semitransparent integrally formed elastic body comprised of a rubber material and overall has a light passing property.

The base 131 of the operating member 13 is arranged on the membrane switch 12 between the pair of front and back long holes 124. When the key top 10 is operated by being pushed, the taper 132 of the operating member 13 elastically deforms and the projection 134 descends. Due to the descending action of the projection 134, a predetermined pushing force acts on the contacts 121 and the top and bottom contacts 121 are closed. If the pushing force of the key top 10 is released, the elastic force of the operating member 13 causes the projection 134 to ascend and the up and down contacts 121 to open (separate).

As shown in FIG. 3, the support member 14 has a housing 15 sticking out from the support panel 11 and a pair of left and right gear links 16 which are supported able to pivot about the housing 15. The housing 15 and the gear links 16 are formed by integrally molding transparent or semitransparent resin as component members and have a light passing property.

The housing 15 exhibits a substantially rectangular frame shape. At the four corners, legs 151 are provided projecting downward. Between the left and right legs 151 of the housing 15, a pair of front and rear side walls 152 extend in the left-right direction. The side walls 152 are respectively provided with pairs of arc-shaped bearing grooves 153, apart from each other in the left-right direction, from the bottom end faces of the side walls toward. The legs 151 project below the side walls 152 and pass through the circular through holes 111. The tips of the legs 151 are thermally calked at the back side of the support panel 11 and thereby fastened to the support panel 11. At this time, the bottom end faces of the side walls 152 abut against the top surface of the support panel 11 passing through the long holes 124 of the membrane switch 12 whereby the housing 15 is supported on the support panel 11 in the state with the operating member 13 arranged at the inside.

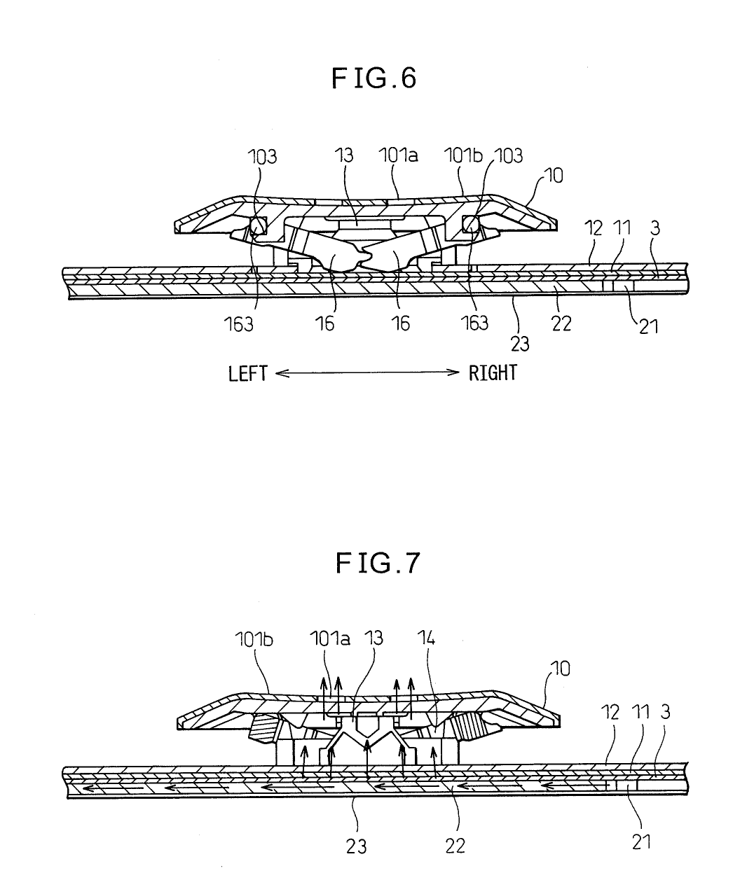

FIG. 5 is a perspective view showing the configuration of the gear links 16. Note that, the left and right gear links 16 form identical shapes. If one gear link 16 were rotated in the horizontal plane by 180 degrees, it would become the other of the gear links 16. Therefore, in FIG. 6, only the other (right side) gear link 16 is shown. The gear link 16 has a trunk 161 which extends in the front-back direction and a pair of front and back arms 162 which extend from the two front and back ends of the trunk 161 in the left direction and overall forms an approximately U-shape. At the back surface of the trunk 161 (right end face), an approximately columnar guide shaft 163 is integrally extended along the trunk 161. The two ends of the guide shaft 163 project out from the two front and back end faces at the arms 162. At the inside surfaces of the tip sides of the arms 162, approximately columnar shaped shafts 164 are projected coaxially toward the front-back direction.

The left end face of the front side arm 162 is formed with a recess 165, while the left end face of the back side arm 162 is formed with a protrusion 166. FIG. 6 is a longitudinal cross-sectional view showing the assembled state of the illuminated keyboard device 100. In the assembled state, the recess 165 of the one gear link 16 in FIG. 3 engages with the protrusion 166 of the other gear link 16, while the protrusion 166 of the one gear link 16 engages with the recess 165 of the other gear link 16. In this state, the housing 15 is inserted into the space between the operating member 13 and the gear links 16 from above, and the housing 15 is fastened to the support panel 11. At this time, the shafts 164 of the gear links 16 engage with the bearing grooves 153 of the housing 15, and the gear links 16 are supported pivotably by the housing 15, whereby, as shown in FIG. 6, a V-shaped gear link of a V-shape when viewed from the side is configured.

The key tops 10 are formed by integral molding of a transparent or semitransparent resin as component members and have a light passing property. As shown in FIG. 2, a key top 10 has a substantially rectangular shaped top 101 and side parts 102 extending downward from the respective sides of the top 101, and overall forms a shallow dish shape opened at the bottom. The key top 10 is coated over its entire surface with a black light blocking paint, then part of the light blocking paint at the top 101 is removed by, for example, heating with a laser etc. Due to this, the top 101 is formed with a light passing part 101a which passes light and with a light blocking part 101b which blocks the passage of light. Note that, in FIG. 2, the light passing part 101a, as one example, forms the letter “A”, but the light passing part 101a forms a letter, number, symbol, etc. differing for each key.

As shown in FIG. 6, at the bottom surface (back side) of the top 101 of a key top 10, guide grooves 103 are formed at four locations, the front, back, left, and right, corresponding to the guide shafts 163 of the gear link 16. The guide shafts 163 are engaged with the guide grooves 103 in a slidable manner. In this state, if the key top 10 is operated by being pushed, the operating member 13 elastically deforms and is pushed flat, whereby the gear links 16 move in opposite directions with each other while coupled with each other. At this time, the guide shafts 163 slide in the guide grooves 103 in the left-right direction, and the key top 10 moves downward in parallel while holding the top 101 in a predetermined substantially horizontal posture.

On the other hand, if the pushing force acting on the key top 10 is removed, the key top 10 moves upward by the elastic force of the operating member 13, while the horizontal posture is held by the gear links 16, until the upper limit position of the key stroke. The upper limit position of a key stroke is defined by the guide shafts 163 of the gear links 16 engaging with the inside walls of the left-right direction of the guide grooves 103 of the key top 10.

In FIG. 2, the backlight unit 2 employs the edge light system and has a light emitting diode (below, LED) 21 as a light source, a light guiding panel 22 through which light from the LED 21 is propagated, and a reflecting sheet 23 which is arranged below the light guiding panel 22. The LED 21 is, for example, a white LED, mounted on a flexible printed circuit board (below, “FPC”) 24 and is arranged at the side end of the light guiding panel 22. The light guiding panel 22 is arranged across the entire region of the illuminated range, that is, the entire region of the plurality of key tops 10. The light from the LED 21 striking the light guiding panel 22 is reflected by the reflecting sheet 23 while being propagated across the entire region of the light guiding panel 22, and is uniformly emitted from the upper surface of the light guiding panel 22 toward the keyboard unit 1.

The color sheet 3, for example, is configured by a transparent PET (polyethylene terephthalate) film which has a light passing property. As shown in FIG. 1, the color sheet 3 is interposed between the light guiding panel 22 and the support panel 11 across the entire region of the illuminated range and is fastened by a transparent adhesive etc. to one or both of the light guiding panel 22 and the support panel 11. The thickness of the color sheet 3 is, for example, 0.2 mm to 0.5 mm or so. The color sheet can be easily cut into the desired shape and is readily available. Not only that, the workability is good. Such color sheets 3 are marketed in various colors such as the red color, blue color, yellow color, etc. It is possible to select and use the desired color sheet 3 from these.

FIG. 7 is a view showing the path of light from the LED 21 in the assembled state of the illuminated keyboard device 100. The light (white light) emitted from the LED 21 is propagated through the light guiding panel 22 over the entire region of the plurality of key tops 10 and is emitted from the entire region of the top surface of the light guiding panel 22. The light guiding panel 22 is arranged below the color sheet 3 so that the light emitted from the light guiding panel 22 passes through the color sheet 3 and is changed to the color in accordance with the color sheet 3. The light changed in color by the color sheet 3 (color changed light) passes through the light-passing through holes 113 and long holes 114 of the support panel 11. Then, the color changed light passes through the membrane switches 12, the operating members 13, and the support members 14 (housing 15, gear links 16) with the light passing property and, further, passes through the light passing parts 101a of the key tops 10.

Due to this, it is possible to illuminate the letter parts of the key tops 10 to predetermined colors and thereby improve the visual recognition at the time of key operation. When changing the illuminated color of the key tops 10, a different colored color sheet 3 is interposed between the support panel 11 and the light guiding panel 12. According to the above first embodiment, a color sheet 3 is sandwiched between the keyboard unit 1 and the backlight unit 2, so by just changing the color sheet 3, it is possible to easily change the specification of illuminated color of the key tops 10 and inexpensively construct the device.

### Second Embodiment

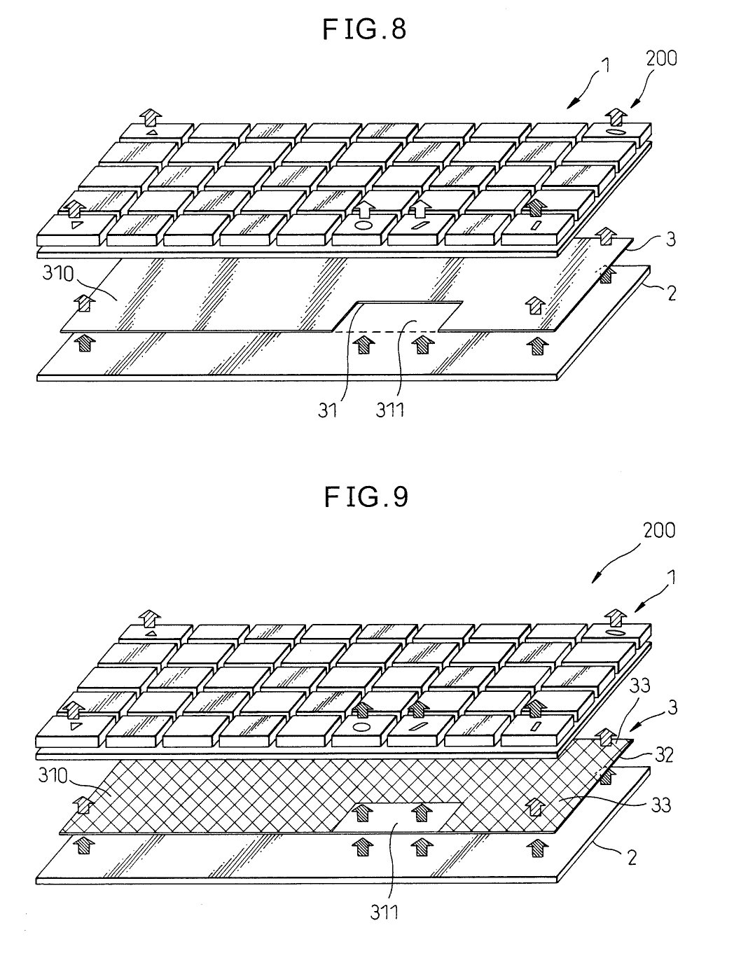

Referring to FIGS. 8 and 9, a second embodiment of the illuminated keyboard device according to the present invention will be explained. In the first embodiment, the color sheet 3 is arranged over the entire region of the illuminated range to change the color of the key tops 10 as a whole to the same color, but in the second embodiment, only part of the illuminated range is changed in color by the color sheet 3. FIG. 8 is a disassembled perspective view showing the overall configuration of the illuminated keyboard device 200 according to the second embodiment of the present invention. Note that, the same parts as in FIG. 1 are assigned the same reference notations. Below, the points of difference from the first embodiment will mainly be explained.

As shown in FIG. 8, the color sheet 3 is provided with a cutaway part 31. Between the keyboard unit 1 and the backlight unit 2, there is therefore provided a region with the color sheet 3 interposed (color changing region 310) and a region with no color sheet 3 interposed (non-color changing region 311). In the color changing region 310, light from the backlight unit 2 is changed in color by the color sheet 3 then passes through the keyboard unit 1. On the other hand, in the non-color changing region 311, light from the backlight unit 2 passes through the cutaway part 31 and then passes through the keyboard unit 1 without being changed in color.

For this reason, the key tops 10 positioned above the color sheet 3 are illuminated by the color changed by the color sheet 3, while the key tops 10 positioned above the non-color changing region 311 are illuminated by the emitted color of the LED 21. Due to this, it is possible to illuminate the key tops 10 above the color changing region and the key tops 10 above the non-color changing region to mutually different colors and utilize the illuminated colors to clearly differentiate the keys.

FIG. 9 is a view showing a modification of FIG. 8. In FIG. 9, the color sheet 3 is comprised of a colorless, transparent PET film 32 which extends over the entire region of the illuminated range and transparent color film 33 having a light passing property which is bonded to the top surface of the PET film 32. That is, the two top and bottom films form the color sheet 3. The color film 33 as a whole is comprised of a predetermined color (for example, red color, blue color, yellow color, etc.). On the top surface of the PET film 32, a non-color changing region 311 not having a color film 33 is formed. Note that, the thickness of the color film 33 is smaller than the thickness of the PET film 32.

Due to this, at the color changing region 310, light from the backlight unit 2 is changed in color by the color film 33 then passes through the key tops 10, while at the non-color changing region 311, light from the backlight unit 2 passes through the key tops 10 as the emitted color of the LED 21. Note that, instead of the color film 33, the top surface of the transparent PET film 32 may also be color printed. In the configuration of FIG. 9, the PET film 32 does not have to be provided with the cutaway part 31 (see FIG. 8), so the work of removing the PET film 32 from the mold is unnecessary or easy. Even if the color changing region 310 is complicated in shape, it can be easily handled. If utilizing printing technology, it is possible to more easily form a complicated shape of a color changing region 310.

### Third Embodiment

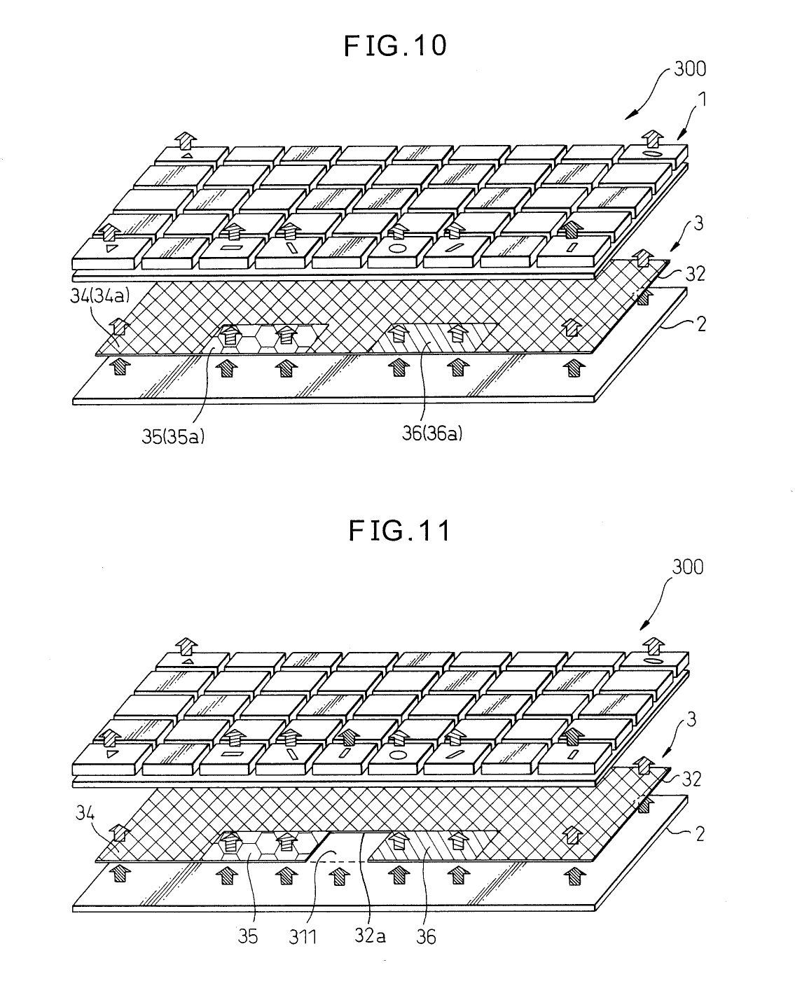

Referring to FIG. 10 to FIG. 12, a third embodiment of an illuminated keyboard device according to the present invention will be explained. In the second embodiment, light emitted from the backlight unit 2 is changed in color to a single color at the color changing region 310, but in the third embodiment, it is changed in color to a plurality of colors. FIG. 10 is a disassembled perspective view showing the overall configuration of an illuminated keyboard device 300 according to the third embodiment of the present invention. Note that, the same parts as in FIG. 8 and FIG. 9 are assigned the same reference numerals. Below, points of difference from the second embodiment will mainly be explained.

The color sheet 3 shown in FIG. 10 is comprised of a colorless, transparent PET film 32 which is extended across the entire region of the illuminated range and transparent color films 34 to 36 having light passing properties which are bonded to the top surface of the PET film 32. The color films 34 to 36 differ from each other in color. The first region 34a, second region 35a, and third region 36a of the top surface of the PET film 32 are arranged without overlap and without clearance. Due to this, the light from the backlight unit 2 passes through the color films 34 to 36 whereby it is changed to different colors. It is therefore possible to illuminate the key tops 10 above the color films 34 to 36 to a plurality of colors in accordance with the color films 34 to 36.

FIG. 11 shows a modification of FIG. 10. In FIG. 11, the color sheet 3 (PET film 32) is provided with a cutaway part 32a whereby a non-color changing region 311 is formed. Due to this, the light from the backlight unit 2 passes through the cutaway part 32a at the non-color changing region 311 and passes through the keyboard unit 1 as the emitted color of the LED 21, whereby the key tops 10 which are positioned above the non-color changing region 311 are illuminated by the LED emitted color. By providing the color sheet 3 with the cutaway part 32a to form the non-color changing region 311 in this way, it is possible to easily increase the illuminated colors of the key tops 10.

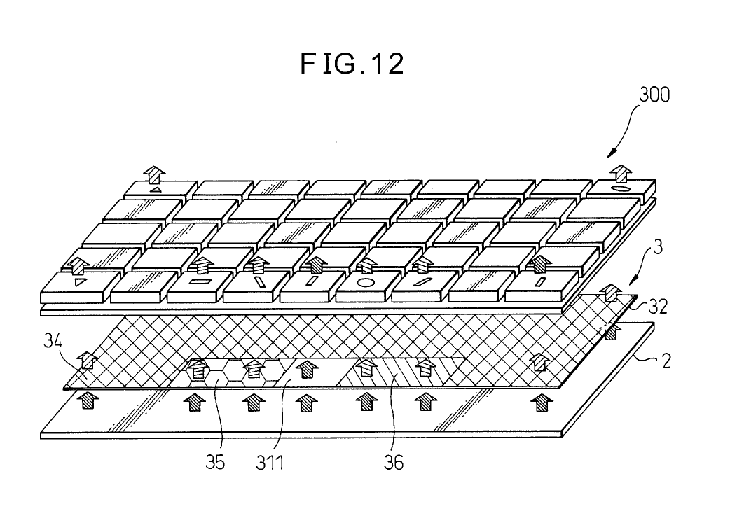

FIG. 12 is a view showing another modification of FIG. 10. In FIG. 12, unlike FIG. 11, the colorless, transparent PET film 32 is not provided with the cutaway part 32a. The top surface of the PET film 32 is formed with a non-color changing region 311 not provided with color films 34 to 36. By this as well, part of the key tops 10 are illuminated with the LED emitted color, so it is possible to increase the illuminated colors of the key tops 10. Note that, in FIG. 10 to FIG. 12, the top surface of the PET film 32 may be color printed while leaving a light passing property instead of bonding the color films 34 to 36 so as to change the color of the light from the backlight unit 2.

In the above embodiment, membrane switches 12 are used to configure the switches, but the configuration of the switches operating by the pushing operation of the plurality of key tops 10 (pushbuttons) which are arranged at the top surface of the keyboard unit 1 is not limited to this. It is also possible to configure the keyboard unit 1 without using the gear links 16 and possible to configure the keyboard unit 1 in various ways. The LED 21 and light guiding panel 22 are used to configure the backlight unit 2, but an organic EL sheet etc. may be used to configure the backlight unit 2. A PET film was used to form the color sheet 3 of the sheet-shaped color changing part, the configuration of the color changing part is not limited to this so long as the part is interposed between the keyboard unit 1 and the backlight unit 2 and changes the color of the light from the backlight unit. The black color light blocking paint coated on the surface of the key tops 10 is removed by laser to form the light passing parts 101a and light blocking parts 101b, but it is also possible to use another method to form the light passing parts and the light blocking parts.

In a third embodiment, color films 34 to 36 are arranged on the top surface of the PET film 32 to change the colors of the first region 34a, the second region 35a and the third region 36a to different colors from each other, but the number of the changed colors is not limited to the above so long as providing a plurality of color changing parts (first color changing part and second color changing part) and changing the colors of a plurality of regions (first region and second region) of the illuminated range to different colors.

According to the present invention, a sheet-shaped color changing part which has a light passing property is provided between the keyboard unit and backlight unit, so it is possible to easily change the illuminated color of the key tops.

Typical embodiments were used to explain the present invention, but it will be understood that a person skilled in the art could make the above changes and various other changes, deletions, and additions without departing from the scope of the present invention.

1. An illuminated keyboard device comprising:
a keyboard unit having a plurality of pushbuttons with a light passing property and switches operating by pushing operation of the plurality of pushbuttons,
a backlight unit emitting light toward the keyboard unit, and
a sheet-shaped color changing part with a light passing property interposed between the keyboard unit and the backlight unit to change a color of light emitted from the backlight unit.

2. The illuminated keyboard device of claim 1, wherein
the switches are membrane switches with a light passing property arranged below the plurality of pushbuttons, and
the color changing part is arranged between the switches and the backlight unit.

3. The illuminated keyboard device of claim 1, wherein
the backlight unit has a LED arranged at its edge, a light guiding panel arranged below the color changing part to emit a light emitted from the LED toward the color changing part, and a reflecting sheet arranged below the light guiding panel to reflect light emitted from the light guiding panel.

4. The illuminated keyboard device of claim 1, wherein
the plurality of pushbuttons have a light blocking part which blocks a passage of the light emitted from the backlight unit and a light passing part which passes the light emitted from the backlight unit, and the light passing part form a predetermined letter, number, or symbol.

5. The illuminated keyboard device of claim 1, wherein
the color changing part is arranged across the entire region of an illuminated range of the plurality of pushbuttons.

6. The illuminated keyboard device of claim 1, wherein
the color changing part is arranged at part of an illuminated range of the plurality of pushbuttons so that the light emitted from the backlight unit passes through part of the plurality of pushbuttons without going through the color changing part.

7. The illuminated keyboard device of claim 5, wherein
the color changing part has a first color changing part arranged at a first region of the illuminated range and a second color changing part arranged at a second region of the illuminated range, and the first color changing part and the second color changing part change the light emitted from the backlight unit to colors different from each other.

8. The illuminated keyboard device of claim 6, wherein
the color changing part has a first color changing part arranged at a first region of the illuminated range and a second color changing part arranged at a second region of the illuminated range, and the first color changing part and the second color changing part change the light emitted from the backlight unit to colors different from each other.
